(19) United States
(12) Patent Application Publication
(10) Pub. No.: US 2014/0158514 A1
(43) Pub. Date: Jun. 12, 2014

(54) METHODS OF SEPARATING SALTS AND SOLVENTS FROM WATER

(71) Applicant: ADVANCED WATER RECOVERY, LLC, Rapid City, SD (US)

(72) Inventors: Rakesh Govind, Cincinnati, OH (US); Robert Foster, Calgary (CA)

(73) Assignee: ADVANCED WATER RECOVERY, LLC, Rapid City, SD (US)

(21) Appl. No.: 14/099,283

(22) Filed: Dec. 6, 2013

Related U.S. Application Data
(60) Provisional application No. 61/734,491, filed on Dec. 7, 2012.
(60) Provisional application No. 61/735,211, filed on Dec. 10, 2012.
(60) Provisional application No. 61/768,486, filed on Feb. 24, 2013.

(51) Int. Cl. C02F 1/08; C02F 1/04; B04C 3/02

(52) U.S. Cl. CPC C02F 1/08; B04C 3/02; C02F 1/043
USPC 202/185.1; 210/512.1; 159/6.1

(57) ABSTRACT

Methods and apparatus for separation of one or more salts from water are described. The methods include addition of a water miscible solvent to the water, followed by separation of the precipitated salt in a slurry, and evaporation of the water miscible solvent from the slurry. The apparatus include a novel design for a wetted wall separator tube that allows the solids in the slurry to pass through while providing efficient evaporation of the water miscible solvent from the water.

### CROSS-REFERENCE TO RELATED APPLICATIONS

This application claims the benefit of the filing date of U.S. Patent Application No. 61/734,491, entitled “Process for Converting Brackish/Produced Water to Useful Products and Reusable Water”, filed on Dec. 7, 2012, U.S. Patent Application No. 61/735,211, entitled “Process for Converting Brackish/Produced Water to Useful Products and Reusable Water,” filed on Dec. 10, 2012, and U.S. Patent Application Ser. No. 61/768,486, entitled “Wetted Wall Separator Tube and Methods of Separating,” filed on Feb. 24, 2013, the disclosures of which are incorporated by reference herein in their entireties.

### FIELD OF THE INVENTION

Aspects of the present invention generally relate to methods of, and apparatus for, separating materials from a liquid, and more specifically relate to methods of, and apparatus for, separating salts from water, such as flowback water from processes such as fracking.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Subsurface geological operations such as mineral mining, oil well drilling, natural gas exploration, and induced hydraulic fracturing generate wastewater contaminated with significant concentrations of impurities. These impurities vary widely in both type and amount depending on the type of geological operation, the nature of the subsurface environment, and the type and amount of soluble minerals present in the native water source. The contaminated water is eventually discharged into surface waters or sub-surface aquifers. In some cases, wastewater generated from drilling and mining operations have resulted in making regional water supplies unusable. Induced hydraulic fracturing (a.k.a. hydro fracturing, or fracking) in particular is a highly water-intensive process, employing water pumped at pressures exceeding 3,000 psi and flow rates exceeding 85 gallons per minute to create fractures in subsurface rock layers. These created fractures intersect with natural fractures, thereby creating a network of flow channels to a well bore. These flow channels allow the release of petroleum and natural gas products for extraction. The flow channels also allow the injected water plus additional native water to flow to the surface along with the fuel products once the fractures are created.

Flowback water, or produced water, from subsurface geological operations contains a variety of contaminants. Often, produced water is “hard” or brackish and further includes dissolved or dispersed organic and inorganic materials. Produced water can include chemicals used in the mining operation, such as hydrocarbons that are injected along with water to facilitate fracture formation in hydrofracturing. One common type of contaminant present is salt (e.g., sodium chloride). In all of these cases, there is a need for low energy-consuming and efficient technologies that can recover reusable water from wastewaters. Since all of these waters contain high concentrations of salts, there is need to be able to remove the soluble salts (such as sodium chloride) from water in an effective, efficient, low-energy, and low-cost manner.

As described above, flowback water (and other contaminated water) may contain salts dissolved in the water. As is known to those of ordinary skill in the art, certain salts readily dissolve in water, others do not, and the solubility rules for salts are as follows:

1. Salts containing Group I elements are soluble (Li⁺, Na⁺, K⁺, Cs⁺, Rb⁺). Exceptions to this rule are rare. Salts containing the ammonium ion (NH⁴⁺) are also soluble.
2. Salts containing nitrate ion (NO³⁻) are generally soluble.
3. Salts containing Cl⁻, Br⁻, I⁻ are generally soluble. Important exceptions to this rule are halide salts of Ag⁺, Pb2⁺, and (Hg₂)²⁺. Thus, AgCl, PbBr₂, and Hg₂Cl₂ are all insoluble.
4. Most silver salts are insoluble. AgNO₃ and Ag(C₂H₃O₂) are common soluble salts of silver; virtually anything else is insoluble.
5. Most sulfate salts are soluble. Important exceptions to this rule include BaSO₄, PbSO₄, Ag₂SO₄ and SrSO₄.
6. Most hydroxide salts are only slightly soluble. Hydroxide salts of Group I elements are soluble. Hydroxide salts of Group II elements (Ca, Sr, and Ba) are slightly soluble. Hydroxide salts of transition metals and Al³⁺ are insoluble. Thus, Fe(OH)₃, Al(OH)₃, Co(OH)₂ are not soluble.
7. Most sulfides of transition metals are highly insoluble. Thus, CdS, FeS, ZnS, Ag₂S are all insoluble. Arsenic, antimony, bismuth, and lead sulfides are also insoluble.
8. Carbonates are frequently insoluble. Group II carbonates (Ca, Sr, and Ba) are insoluble. Some other insoluble carbonates include FeCO₃ and PbCO₃.
9. Chromates are frequently insoluble. Examples: PbCrO₄, BaCrO₄.
10. Phosphates are frequently insoluble. Examples: Ca₃(PO₄)₂, Ag₃PO₄.
11. Fluorides are frequently insoluble. Examples: BaF₂, MgF₂ PbF₂.

Most alkali chlorides are soluble in water. And, the solubility of most salts increases with temperature. Sodium chloride is an example of a highly soluble salt having a solubility that increases with temperature. As described above, sodium chloride is one of the most prevalent contaminants in water (such as flowback water), and so it would be beneficial to be able to remove salt such as sodium chloride (as well as other salts) in an effective, efficient, low-energy, low-cost manner.

However, until recently, there had been no simple methods to remove salts such as sodium chloride from water that met these goals. Two methods that have been traditionally used involve either (1) evaporation of water until the salt solution becomes supersaturated and salt begins to precipitate or (2) by freezing water to form pure ice, which allows the salt concentration to increase in the liquid water portion [this process, coupled with the lowered solubility at freezing temperatures (below 32° F.), allows salt to be precipitated from solution]. Unfortunately, both of these methods consume a large amount of energy, which is undesirable. Further, neither of these processes is rapid. The use of such methods to remove salts other than sodium chloride suffers the same or similar drawbacks.

However, in U.S. Application No. 61/757,891, incorporated by reference herein in its entirety, the same inventors on this present application describe a method of removing salts (such as sodium chloride) in an effective, efficient, low-energy, low-cost manner. That application discloses a technique of using a low-boiling, water-miscible solvent to precipitate sodium chloride or another salt from a solution thereof. In some embodiments, the water miscible solvent is an organic solvent, that is, a solvent containing hydrocarbyl functionality. In some embodiments the salt solution is sea water, brine, brackish water, waste water from an industrial process, produced water from a mining operation, or a partially treated byproduct of one of more of these. For example, brine or produced water from a mining operation is pretreated, in some embodiments, to remove one or more materials such as oily residues, gel particles, suspended solids, strontium, calcium, or a mixture of two or more thereof.

However, once salt has been precipitated, an issue that remains is how to separate the solvent from the salt slurry that is formed once salt is precipitated. U.S. Application No. 61/757,891 does not address an effective, efficient separation apparatus and a method of efficient separation of the water miscible solvent from the salt slurry that results from the solvent-induced salt precipitation. Further, methods currently known for separation of solvents are largely inadequate in the present processes, for myriad reasons (described below).

Methods previously used to separate solvents from liquids include those using contact of a gas with liquid to promote separation, such as through evaporation. And, there are many devices that have been developed for contacting a gas with a liquid. These include, for example: (1) packed columns, which use media, made from plastic, ceramic, etc., that is either randomly packed or is structured inside a vessel, with gas flowing upward and liquid trickling downward, such that a thin film of liquid that is formed on the outside surface of the media presents a high surface area between the gas and the liquid; (2) spray towers, in which liquid is sprayed in the form of small droplets, and gas flows upward counter to the falling drops; (3) devices where gas is bubbled through a column of liquid, with the gas being bubbled through porous media to form small bubbles, that present a very high surface area between the gas and liquid; (4) membrane contactors, using a porous, hollow fiber membrane, with gas flowing inside the hollow fibers and liquid flowing outside the hollow fiber bundle, with mass transfer occurring through the membrane pores between the gas and liquid phases; (5) venturi systems in which the gas or liquid is drawn in at the throat of the venturi with the other phase flowing through the venturi, thereby allowing turbulent contact between the gas and liquid phases (for example, liquid flows through the venturi while gas is drawn in at the throat due to lower pressure created by the high velocity of the liquid, and the gas forms very small bubbles in the liquid flow, presenting a very high surface area in a very turbulent liquid flow); and (6) other forms of kinetic devices, such as spinning disks, etc., having the objective of shearing the liquid into tiny packets of fluid inside the gas phase.

However, all the apparatus and methods described above include drawbacks that prevent their use in the presently described situation. These drawbacks include the use of too much energy, the problem with clogging of the systems, an inability to efficiently heat or cool the liquid phase, and a large size. For example, with respect to energy consumption, if the gas has to be bubbled through a column of water, then the gas has to be pressurized, depending on the height of the water column. This requires considerable energy to pressurize the gas flow. If the liquid has to be sprayed in the form of small droplets in the gas phase, considerable pressure in the liquid phase is needed to create small droplets of liquid, etc. Further, devices such as packed towers easily clog if there are solids present in the liquid or gas phases. Further, in most of the methods mentioned above, simultaneous heat and mass transfer is not achievable. And finally, packed towers are generally large in diameter, having a large footprint, which is undesirable.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

One aspect of the present invention provides methods of separating water soluble salts from an aqueous solution. One embodiment of such a method may include (1) adding a solvent to a solution of salt in liquid to form an aqueous mixture, wherein the mass ratio of the solvent to the total volume of aqueous mixture is about 0.05 to 0.3; (2) separating a salt slurry from the aqueous mixture; and (3) evaporating the water miscible solvent from the salt slurry to form a concentrated salt slurry.

That method of separating water soluble salts from an aqueous solution may more specifically include—in certain embodiments—(1) adding a water miscible solvent to a solution of salt in water to form an aqueous mixture, wherein the mass ratio of the water miscible solvent to the total volume of aqueous mixture is about 0.05 to 0.3, and wherein the water miscible solvent is characterized by (a) infinite solubility in water at 25° C.; (b) a boiling point of greater than 25° C. at 0.101 MPa; (c) a heat of vaporization of about 0.5 cal/g or less; and (d) no capability to form an azeotrope with water; (2) separating a salt slurry from the aqueous mixture; and (3) evaporating the water miscible solvent from the salt slurry to form a concentrated salt slurry.

Another aspect of the present invention provides a system for separating a solvent from an aqueous mixture. The system may include (1) a separator including: (a) a housing having at least one wall defining an interior space, an open top end, and an open bottom end, wherein the at least one wall has an inner surface and an outer surface; and (b) a contour disposed on or defined by at least a portion of the inner surface of the at least one wall; and (2) wherein a flow path for an aqueous mixture is provided by at least a portion of the contour and the inner surface of the at least one wall.

One example of a separator is a wetted wall column (such as a wetted wall static separator). While wetted wall columns have been known in the prior art, they were developed for quantitatively determining the mass transfer coefficient in laboratories, and have never been used for industrial applications, mainly due to two reasons. First, the surface area is very limited, and so they would not be considered an efficient apparatus to use at the high flow rates of water in processes such as fracking. In wetted wall columns, the contact surface area between the gas and liquid phases is basically pi*D*L where pi=3.142, D is the inner diameter of the tube and L is the length of the tube. Thus, even if one uses multiple tubes, the total surface area would be limited, or the number of tubes needed to operate in an industrial use, such as at fracking flow rates, would be prohibitive. The second reason such columns have not been used in industrial applications is because the flow of liquid down the inner surface of the tube is initially laminar and then gets turbulent beyond a certain length, as the liquid flows downwards due to gravity. Because the initial part of the flow is laminar, it will have poor mass transfer characteristics. And so, this initial entrance region with laminar flow has limited applicability in industrial applications wherein high mass transfer rates are desired.

Due to these limitations, wetted wall columns have been confined to laboratories and are basically used to teach the principles of mass transfer to chemical engineering students or to quantify the mass transfer coefficient for a given gas-liquid system. However, the particular separator (e.g., wetted wall column) of the present invention is structured in a novel manner that allows for its effective use in removing solvent on the scale needed.

The wetted wall separator tube may include, in one embodiment, a hollow cylindrical pipe having a top opening, a bottom opening, an inner wall, and an outer wall, and further including a helical threaded feature disposed on at least a portion of the inner wall. In other words, in this embodiment, the helical threaded feature is the contour described above.

A further aspect of the present invention provides an evaporator apparatus including one or more wetted wall separator tubes comprising a hollow cylindrical pipe having a top opening, a bottom opening, an inner wall, and an outer wall, and including a helical threaded feature disposed on at least a portion of the inner wall. The evaporating further contemplates, in some embodiments, the use of a wetted wall separation tube in the shape of a hollow cylinder or a pipe, or it can be a hollow frustoconical shape, or a hollow cylinder or a pipe having a frustoconical portion.

In certain embodiments, the tube includes an inner wall and an outer wall, wherein a contour defined by at least a portion of the inner wall. In certain embodiments, the contour may include a helical threaded feature defined by at least a portion of the inner wall, or disposed on or in at least a portion of the inner wall. In some embodiments, the helical threads are of substantially the same dimensions throughout the portion of the inner wall where they are located; in other embodiments, helical threads of different dimensions occupy different continuous or discontinuous areas of the tube. The helical shape is easy to manufacture using a mandrel, and it also provides a gravity force for solids to slide down, instead of having obstructions that would allow the solids to build up.

In some embodiments, a series of fins defines at least a portion of the outer wall. In some embodiments, the tubes also include one or more weirs proximal to, or spanning the opening of one end of the tube. In some embodiments, the tubes also include a smooth inner wall portion proximal to one end of the tube.

In certain embodiments, one or more wetted wall separation tubes may be employed to carry out the evaporating described above. The method of evaporating the water miscible solvent from the aqueous mixture may include disposing the tube in a vertical position, flowing a salt slurry into the top opening, and allowing the slurry to proceed down the tube as aided solely by gravity. In some embodiments, a vacuum is applied to the top of the tube, or a flow of air or another gas is applied through the bottom of the tube, or both. Movement of gas upward through the tube maximizes the evaporation rate of the water-miscible solvent. In some embodiments, the tube is heated in order to mitigate the loss of heat of evaporation. In some embodiments, a significant amount of the precipitated salt follow the path of the helical thread and proceeds in a circular pattern downward through the tube, while the water/water miscible solvent blend flows substantially vertically, such that the helices present multiple “weirs” or walls over which the water flows. This in turn causes turbulence in the vertical flow. The turbulent flow aids in the evaporation of the water miscible solvent. In some embodiments, the turbulent flow is substantially separate from the substantially laminar flow that proceeds within the helical threads. The water at the bottom of the tube is significantly free, or substantially free, of the water miscible organic solvent.

It is an advantage of the wetted wall separator tubes of the invention that the length of the tubes, and the number thereof employed in the evaporation process, are easily selected and optimized in order to achieve the separation of the selected water miscible solvent from the slurry formed in the separation.

In some embodiments, the method further includes isolating the solid salt after evaporating the solvent from the slurry. In some embodiments, the flow within the helical threads is substantially laminar, and so the precipitated salt particles or crystals do not tend to re-mix with the water as the water miscible solvent is evaporated. Thus, the particles may be dispensed from the bottom of the tube in precipitated form. In such embodiments, the precipitated salt from the slurry added to the top of the tube is substantially recovered at the bottom of the tube. The isolating may be carried out using conventional means, such as filtration. The water that is also recovered in the isolation has significantly reduced, or even substantially reduced salt content compared to the solution of salt in water that was employed to form the aqueous mixture.

In some embodiments, the tubes may be surrounded by a source of heat to aid in the evaporation. In some embodiments, the water miscible organic solvent is collected by providing a condenser or other means of trapping the evaporated solvent that exits the top of the wetted wall separator tubes due to the flow of gas upward through the tubes. The evaporated solvent is significantly free, or substantially free, of evaporated water, which enables the isolation of sufficiently pure solvent. The ability to collect the water miscible solvent enables the solvent to be incorporated in a closed system of solvent recycling within the overall precipitation and evaporation process.

The concept disclosed herein, namely, that of the separation of evaporated solvent from a liquid-solid slurry while maintaining the separation of the solid from the liquid, is applicable to other systems as well. For example, in wastewater remediation, anaerobic digesters are employed to digest waste products, and produce a substantial amount of ammonia gas which remains dissolved in the water. The separator tubes of the invention are useful to provide separation of the ammonia from the water, while maintaining separate flows of the solid waste from the liquid. At the end of the tube, the solid is easily isolated from the liquid and the ammonia is stripped away from the liquid.

It will be appreciated that depending on the type of gas-liquid-solid separation to be carried out, the ratio of liquid to solid in the slurry, and the flow rate selected for the slurry through the tube, the inner diameter of the tube, the helix angle of the helical thread, and the dimensions of the helical features will necessarily be different in order to effect the most efficient separation.

Thus, the present invention, in certain aspects, provides a wetted wall column from separation of solvent from a salt slurry. As was described above, wetted wall columns have been known. However, they were developed for quantitatively determining the mass transfer coefficient in laboratories, and have never been used industrially for any application.

The separator (such as a wetted wall column including a contour feature) described herein overcomes the limitations of, for example, wetted wall columns of the prior art, which could not be used on an industrial scale for such separations. This is due at least to the following non-limiting list of novel features and aspects of the separator, system, and method of the present invention:

First, in the present separator, the tubes have a projection or projections inside the tube (e.g., contour, such as a helical threaded feature) that allow the liquid flow to get turbulent right away (as opposed to laminar flow) and additionally creates a very large surface area between the turbulent liquid flow and the gas phase (which enhances the volume and rate of evaporation of solvent—and thus separation of same—from liquid). Second, the contact surface area between the gas and liquid phases is not just pi*D*L, as in the case of laminar flow, but significantly higher as the liquid flow is broken down by the projection or projections (i.e., contour or contours) into many small flows and creates mixing of the liquid as it flows downwards by gravity. Third, by having the contour or contours inside the tube, and corrugated fins outside 9 as will be described in greater detail below), a large surface area is created for heat transfer into the liquid phase. Thus, the separators (e.g., wetted wall columns) of the present invention achieve not only a very high mass transfer coefficient, but a high heat transfer coefficient for effective heat transfer into the liquid phase. Fourth, a very large number of tubes can be fit inside a very small diameter shell; thus, various embodiments of the present invention contemplate and allow for a compact system. And fifth, if there are solids present in the liquid flow, the tubes will not get clogged, as in the case of plastic media packed towers. Rather, as described above, the contour or contours can be designed to allow for any solids present to proceed to an exit point of the separator.

These and other advantages of the application will be apparent to those of skill in the art with reference to the drawings and the detailed description below.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 shows a schematic representation of an apparatus of the invention.

FIG. 2A shows a schematic representation of another apparatus of the invention.

FIG. 2B shows a detail of one part of the apparatus of FIG. 2A.

FIG. 3 shows a schematic representation of an experimental setup.

FIG. 4 is a plot of mass transfer number as a function of Reynolds Number for a water/ammonia solution in a control experiment.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One aspect of the present invention provides method of separating water soluble salts from an aqueous solution. The method may include (1) adding a solvent to a solution of salt in liquid to form an aqueous mixture, wherein the mass ratio of the solvent to the total volume of aqueous mixture is about 0.05 to 0.3; (2) separating a salt slurry from the aqueous mixture; and (3) evaporating the water miscible solvent from the salt slurry to form a concentrated salt slurry.

That method of separating water soluble salts from an aqueous solution may more specifically include—in certain embodiments—(1) adding a water miscible solvent to a solution of salt in water to form an aqueous mixture, wherein the mass ratio of the water miscible solvent to the total volume of aqueous mixture is about 0.05 to 0.3, and wherein the water miscible solvent is characterized by (a) infinite solubility in water at 25° C.; (b) a boiling point of greater than 25° C. at 0.101 MPa; (c) a heat of vaporization of about 0.5 cal/g or less; and (d) no capability to form an azeotrope with water; (2) separating a salt slurry from the aqueous mixture; and (3) evaporating the water miscible solvent from the salt slurry to form a concentrated salt slurry.

Thus, one aspect of the present invention involves precipitating salt out of the water using a solvent. The solvent may be an organic solvent. To that end, ethanol precipitation is a widely used technique to purify or concentrate nucleic acids. In the presence of salt (in particular, monovalent cations such as sodium ions), ethanol efficiently precipitates nucleic acids. Nucleic acids are polar, and a polar solute is very soluble in a highly polar liquid, such as water. However, unlike salt, nucleic acids do not dissociate in water since the intramolecular forces linking nucleotides together are stronger than the intermolecular forces between the nucleic acids and water. Water forms solvation shells through dipole-dipole interactions with nucleic acids, effectively dissolving the nucleic acids in water. The Coulombic attraction force between the positively charged sodium ions and negatively charged phosphate groups in the nucleic acids is unable to overcome the strength of the dipole-dipole interactions responsible for forming the water solvation shells.

The Coulombic Force between the positively charged sodium ions and negatively charged phosphate groups depends on the dielectric constant (E) of the solution, and is given by the following equation:

$$F = \frac{{q}_{1} {q}_{2}}{4 {πɛ}_{o} {ɛ}_{r} {r}^{2}} = 8.9875 \times {10}^{9} \frac{{q}_{1} {q}_{2}}{{ɛ}_{r} {r}^{2}} newtons$$

Adding a solvent, such as ethanol to a nucleic acid solution in water lowers the dielectric constant, since ethanol has a much lower dielectric constant than water (24 vs 80, respectively). This increases the force of attraction between the sodium ions and phosphate groups in the nucleic acids, thereby allowing the sodium ions to penetrate the water solvation shells, neutralize the phosphate groups and allowing the neutral nucleic acid salts to aggregate and precipitate out of the solution [as described in Pigkur, Jure, and Allan Rupprecht, “Aggregated DNA in ethanol solution,” FEBS Letters 375, no. 3 (November 1995): 174-8, and Eickbush, Thomas, and Evangelos N. Moudrianakis, “The compaction of DNA helices into either continuous supercoils or folded-fiber rods and toroids,” Cell 13, no. 2 (February 1978): 295-306, the disclosures of which are incorporated by reference herein in their entireties].

One aspect of the present invention, then, contemplates that the principles regarding the precipitation of nucleic acids via the introduction of water miscible solvents can also be used to precipitate soluble salts, which, like nucleic acids, have solvation shells formed around the ions. Thus, by lowering the dielectric constant of the solution, the Coulombic attraction between the oppositely charged ions can be increased to cause the neutral salts to precipitate out of solution. This general concept has been discussed by Alfassi, Z B, L Ata. “Separation of the system NaCl—NaBr—NaI by Solventing Out from Aqueous Solution,” Separation Sci. and Technol. 18, no. 7 (1983): 593-601, incorporated by reference herein in its entirety.

Another aspect of the present invention provides a system for separating a solvent (such as the solvent used to precipitate a salt or salts) from an aqueous mixture. The system may include (1) a separator including: (a) a housing having at least one wall defining an interior space, an open top end, and an open bottom end, wherein the at least one wall has an inner surface and an outer surface; and (b) a contour disposed on, or in, or defined by, at least a portion of the inner surface of the at least one wall; and (2) wherein a flow path for an aqueous mixture may be provided by at least a portion of the contour and the inner surface of the at least one wall.

One example of a separator is a wetted wall column. As is known to those of ordinary skill in the art, a wetted wall column is a vertical column that operates with the inner wall or walls thereof being wetted by the liquid being processed, and these columns are used in theoretical studies of mass transfer rates and in analytical distillations. Thus, while wetted wall columns have been known in the prior art, they were developed for quantitatively determining the mass transfer coefficient in laboratories (i.e., the theoretical studies referenced above), and have never been used for industrial applications, mainly due to two reasons. First, the surface area of a wetted wall column is very limited, and so such a column would not be considered an efficient apparatus to use at the high flow rates of water in processes such as fracking. In wetted wall columns, the contact surface area between the gas and liquid phases is basically pi*D*L where pi=3.142, D is the inner diameter of the tube and L is the length of the tube. Thus, even if one uses multiple tubes, the total surface area would be limited, or the number of tubes needed to operate in an industrial use, such as at fracking flow rates, would be prohibitive. The second reason such columns have not been used in industrial applications is because the flow of liquid down the inner surface of the tube is initially laminar and then gets turbulent beyond a certain length, as the liquid flows downwards due to gravity. Because the initial part of the flow is laminar, it will have poor mass transfer characteristics. And so, this initial entrance region with laminar flow has limited applicability in industrial applications wherein high mass transfer rates are desired.

Due to these limitations, wetted wall columns have been confined to laboratories and are basically used to teach the principles of mass transfer to chemical engineering students or to quantify the mass transfer coefficient for a given gas-liquid system. However, the particular separator (e.g., wetted wall column) of the present invention is structured in a novel manner that allows for its effective use in removing solvent on the scale needed.

To that end, the separator of the present invention may be, in one embodiment, a hollow cylindrical pipe having a top opening, a bottom opening, an inner wall, and an outer wall, and further including a contour disposed on at least a portion of the inner wall. The separator may be a wetted wall column. The contour may be, for example, a helical threaded feature disposed in, or on, or associated with at least a portion of the inner wall of the tube. It should be noted that while this embodiment is described as a tube (which would be generally thought to have a circular or oval or similar cross-section), the separators described herein are not limited to tubes, but may include housings having multiple walls and cross-sections other than circular, oval, or similar (such as square, triangular, or trapezoidal cross-sections, for example).

A further aspect of the present invention provides an evaporator apparatus including one or more separators, which may be one or more wetted wall columns including a hollow cylindrical tube having a top opening, a bottom opening, an inner wall, and an outer wall, and including a contour (such as a helical threaded feature) disposed on, or in, or associated with, at least a portion of the inner wall. The evaporating further contemplates, in some embodiments, the use of a wetted wall separation tube in the shape of a hollow cylinder or a pipe, or it can be a hollow frustoconical shape, or a hollow cylinder or a pipe having a frustoconical portion.

In certain embodiments, the tube includes an inner wall and an outer wall, wherein a contour is defined by at least a portion of the inner wall (or alternatively, may be positioned on, or otherwise associated with, the inner wall). In certain embodiments, the contour may include a helical threaded feature defined by at least a portion of the inner wall, or disposed on, or in, at least a portion of the inner wall. In some embodiments, the helical threads are of substantially the same dimensions throughout the portion of the inner wall where they are located; in other embodiments, helical threads of different dimensions occupy different continuous or discontinuous areas of the tube. The helical shape is useful in certain embodiments of the present invention, as it is easy to manufacture using a mandrel, and it also provides a gravity force for solids (which may be separated from any liquids) to travel along, instead of having obstructions that would allow the solids to build up within the separator.

In some embodiments, a series of fins defines at least a portion of the outer wall. In some embodiments, the tubes also include one or more weirs proximal to, or spanning the opening of one end of the tube. In some embodiments, the tubes also include a smooth inner wall portion proximal to one end of the tube.

In certain embodiments, one or more wetted wall separation tubes may be employed to carry out the evaporating described above. The method of evaporating the water miscible solvent from the aqueous mixture may include disposing the tube in a vertical position, flowing a salt slurry into the top opening, and allowing the slurry to proceed down the tube as aided solely by gravity. In some embodiments, a vacuum is applied to the top of the tube, or a flow of air or another gas is applied through the bottom of the tube, or both. Movement of gas upward through the tube maximizes the evaporation rate of the water-miscible solvent. In some embodiments, the tube is heated in order to mitigate the loss of heat of evaporation. In some embodiments, a significant amount of the precipitated salt follow the path of the helical thread and proceeds in a circular pattern downward through the tube, while the water/water miscible solvent blend flows substantially vertically, such that the helices present multiple “weirs” or walls over which the water flows. This in turn causes turbulence in the vertical flow. The turbulent flow aids in the evaporation of the water miscible solvent. In some embodiments, the turbulent flow is substantially separate from the substantially laminar flow that proceeds within the helical threads. The water at the bottom of the tube is significantly free, or substantially free, of the water miscible organic solvent.

It is an advantage of the wetted wall separator tubes of the invention that the length of the tubes, and the number thereof employed in the evaporation process, are easily selected and optimized in order to achieve the separation of the selected water miscible solvent from the slurry formed in the separation. The general characteristics that are used to determine how to achieve such optimization are: (a) the mass transfer coefficient between the gas and liquid phase, which depends on the liquid flow rate per tube and the length of each tube (the liquid flow rate per tube=Q/N, where Q=total liquid flow rate, and N=number of vertical tubes); (b) the mass transfer coefficient, which gives the amount of organic solvent that can be evaporated per tube; and (c) the liquid flow rate per tube, which will be selected to prevent dry spots within the inner surface of the tube, as well as prevent a low mass transfer coefficient. Measuring or calculating these characteristics are within the knowledge of one of ordinary skill in the art.

One of ordinary skill in the art (with knowledge of the above characteristics) will then be able to determine a reasonable number of tubes for a selected length of tube in order to achieve the separation desired. By this manner, and as will be described in greater detail below with respect to systems for separation, one can then effectively separate a solvent from a liquid at the volumes and flow rates needed to treat liquids in industrial processes—which heretofore has not been achieved.

The separator (such as a wetted wall column including a contour feature) described herein overcomes the limitations of, for example, wetted wall columns of the prior art, which could not be used on an industrial scale for such separations. This is due at least to the following non-limiting list of novel features and aspects of the separator, system, and method of the present invention:

First, in the present separator, the tubes have a projection or projections inside the tube (e.g., contour, such as a helical threaded feature) that allow the liquid flow to get turbulent right away (as opposed to laminar flow) and additionally creates a very large surface area between the turbulent liquid flow and the gas phase (which enhances the volume and rate of evaporation of solvent—and thus separation of same—from liquid). Second, the contact surface area between the gas and liquid phases is not just pi*D*L, as in the case of laminar flow, but significantly higher as the liquid flow is broken down by the projection or projections (i.e., contour or contours) into many small flows and creates mixing of the liquid as it flows downwards by gravity. Third, by having the contour or contours inside the tube, and corrugated fins outside 9 as will be described in greater detail below), a large surface area is created for heat transfer into the liquid phase. Thus, the separators (e.g., wetted wall columns) of the present invention achieve not only a very high mass transfer coefficient, but a high heat transfer coefficient for effective heat transfer into the liquid phase. Fourth, a very large number of tubes can be fit inside a very small diameter shell; thus, various embodiments of the present invention contemplate and allow for a compact system. And fifth, if there are solids present in the liquid flow, the tubes will not get clogged, as in the case of plastic media packed towers. Rather, as described above, the contour or contours can be designed to allow for any solids present to proceed to an exit point of the separator.

In another aspect, the method of the present invention may further include isolating any solid salt (e.g., any precipitated or otherwise non-dissolved salt) after separating solvent from a slurry (such as via evaporation by using one or more wetted wall columns as described herein). In some embodiments, the flow within the helical threads is substantially laminar, and so the precipitated salt particles or crystals do not tend to re-mix with the water as the water miscible solvent is evaporated. Thus, the particles may be dispensed from the bottom of the tube (or tubes) in precipitated form. In such embodiments then, the precipitated salt from the slurry added to the top of the tube is substantially recovered at the bottom of the tube. The isolating of the salt may be carried out using conventional means, such as filtration. The water that is also recovered in the isolation thus has significantly reduced, or even substantially reduced, salt content compared to the solution of salt in water that was employed to form the aqueous mixture (i.e., the aqueous mixture is the mixture of salt water and salt that was in the feed to the system).

In some embodiments, the tubes may be surrounded by a source of heat to aid in the evaporation. In some embodiments, the water miscible organic solvent is collected by providing a condenser or other means of trapping the evaporated solvent that exits the top of the wetted wall separator tubes due to the flow of gas upward through the tubes. The evaporated solvent is significantly free, or substantially free, of evaporated water, which enables the isolation of sufficiently pure solvent. The ability to collect the water miscible solvent enables the solvent to be incorporated in a closed system of solvent recycling within the overall precipitation and evaporation process.

The concept disclosed herein, namely, that of the separation of evaporated solvent from a liquid-solid slurry while maintaining the separation of the solid from the liquid, is applicable to other systems as well. For example, in wastewater remediation, anaerobic digesters are employed to digest waste products, and produce a substantial amount of ammonia gas which remains dissolved in the water. The separator tubes of the invention are useful to provide separation of the ammonia from the water, while maintaining separate flows of the solid waste from the liquid. At the end of the tube, the solid is easily isolated from the liquid and the ammonia is stripped away from the liquid.

It will be appreciated that depending on the type of gas-liquid-solid separation to be carried out, the ratio of liquid to solid in the slurry, and the flow rate selected for the slurry through the tube, the inner diameter of the tube, the helix angle of the helical thread, and the dimensions of the helical features will necessarily be different in order to effect the most efficient separation. However, as described above, once the relevant characteristics of the separation are calculated or measured (relative to a separator of the present invention) one of ordinary skill in the art would be able to make such a determination how to optimize a system to effect the most efficient separation.

### DEFINITIONS

As used herein, the term “salt” means an ionic compound that undergoes dissociation in water at 25° C. The salt can have organic functionality, but in many embodiments is inorganic. The salt is a single salt species or a mixture of salts.

As used herein, the term “water miscible solvent” means an organic or inorganic solvent or mixture of two or more solvents. The solvent or mixture thereof is characterized by infinite solubility in water at 25° C., a boiling point of greater than 25° C. at 0.101 MPa, a heat of vaporization of about 0.5 cal/g or less, and no capability to form an azeotrope with water at any temperature.

As used herein, the term “significant” or “significantly” means at least half. For example, a solution that contains a “significant amount” of a component contains 50% or more of that component by weight, or by volume, or by some other measure as appropriate and in context. A solution wherein a significant portion of a component has been removed has had at least 50% of the original amount of that component removed by weight, or by volume, or by some other measure as appropriate and in context.

As used herein, the term “substantial” or “substantially” means nearly completely, and includes completely. For example, a solution that is “substantially free” of a specified compound or material may be free of that compound or material, or may have a trace amount of that compound or material present, such as through unintended contamination or incomplete purification. A composition that has “substantially only” a provided list of components may consist of only those components, or have a trace amount of some other component present, or have one or more additional components that do not materially affect the properties of the composition. For example, a “substantially planar” surface may have minor defects, or embossed features that do not materially affect the overall planarity of the film. In terms of compositions, “substantially” means greater than about 90%, for example about 95% to 100%, or about 97% to 99.9%, for example by weight, or by volume, or by some other measure as appropriate and in context.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the term “optional” or “optionally” means that the subsequently described event or circumstance may but need not occur, and that the description includes 15 instances where the event or circumstance occurs and instances in which it does not.

Herein, methods and apparatus will be described for the separation of materials, such as salts or solvents, from water. At times, this water may be referred to as “hard” water, or “brackish” water, or “produced” water, or another type of water (which may even include waters not subjected to subsurface geological operations, such as seawater). However, those of ordinary skill in the art will recognize that the methods and apparatus described do not have to be seen as only used with the particular type of water mentioned (whether “wastewater,” “produced,” “hard,” “brackish,” “flowback,” “contaminated,” etc.), but with any water from any source containing a material or materials that one wishes to remove.

### Separation Apparatuses and Methods

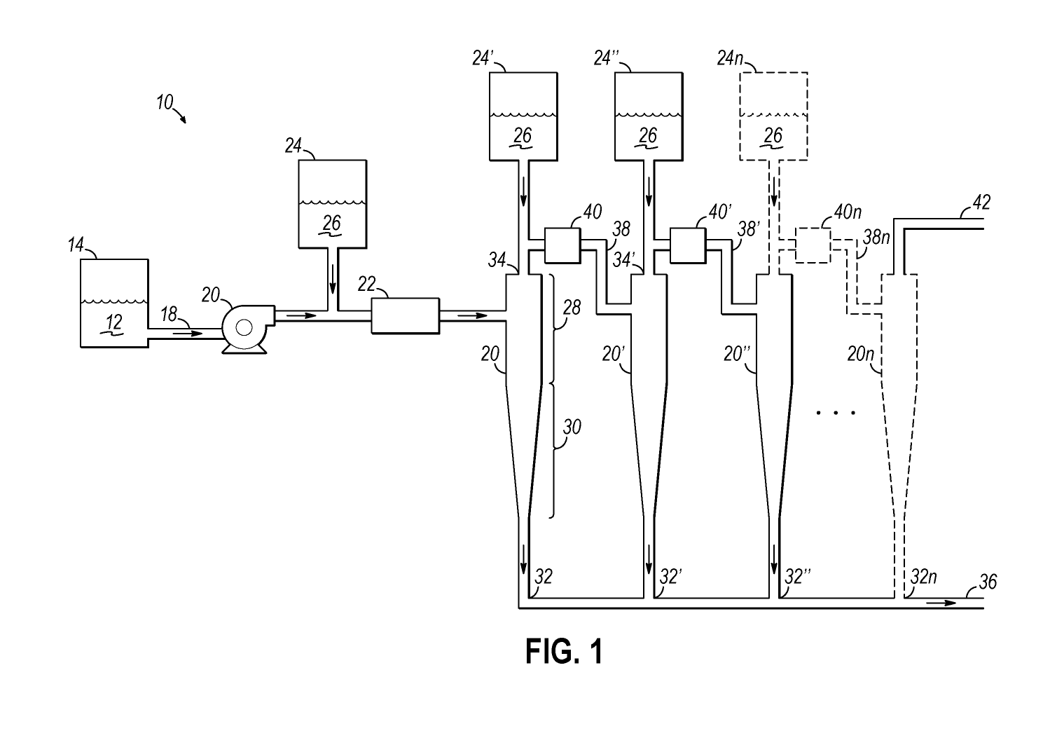

Referring to FIG. 1, a system 10 is shown that includes apparatus suitable for carrying out the methods of the various aspects of the invention. A liquid 12 (such as water), having one or more inorganic salts dissolved therein, such as sodium chloride, magnesium chloride, or calcium chloride, enters from source 14 via pump 16. Path 18 connects the source 14 to at least one hydrocyclone 20. Path 18 includes an in-line mixing apparatus 22. Also connected to path 18, between pump 16 and in-line mixing apparatus 22, is water miscible organic solvent source 24 including solvent 26. Thus, an initial amount of water miscible organic solvent 26, delivered from solvent source 24, is added to water 12 from source 14 in path 18, and the two components are mixed with in-line mixing apparatus 22, resulting in precipitation of some amount of the salt present in the water 12. Path 18 dispenses the mixture into hydrocyclone 20.

Hydrocyclones, in general, are devices that separate particles in a liquid suspension based on the ratio of their centripetal force to fluid resistance. Hydrocyclones generally (and as in the illustrated embodiment) have a cylindrical section 28 at the top where the slurry or suspension is fed tangentially, and a conical base 30. The angle, and hence length of the conical section, plays a role in determining operating characteristics. The hydrocyclone has two exits: a smaller exit 32 on the bottom (underflow) and a larger exit 34 at the top (overflow). The underflow is generally the denser or coarser fraction, while the overflow is the lighter or finer fraction.

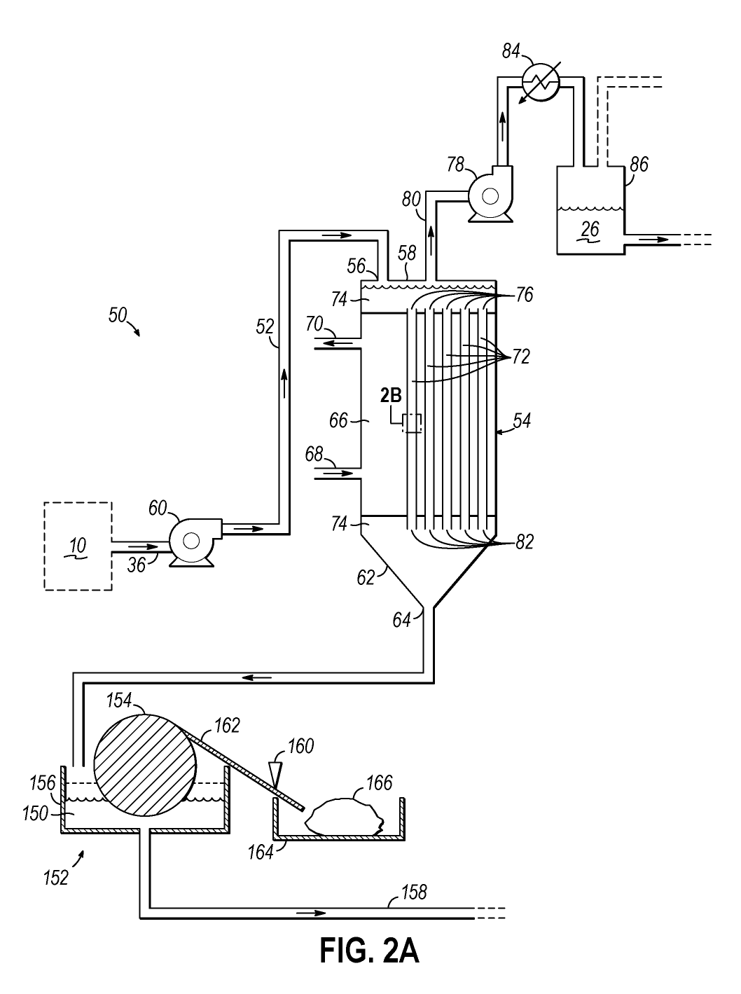

Within hydrocyclone 20, a concentrated salt slurry is separated from the aqueous mixture and dispensed at exit point 32 as an underflow. The concentrated salt slurry includes at least water, precipitated salt, and water miscible solvent. The concentrated slurry has a greater amount of precipitated salt than the overflow. The underflow exiting from exit point 32 of hydrocyclone 20 is channeled via pathway 36 to the system shown in FIG. 2A. The overflow from hydrocyclone 20 is directed via path 38 to a second hydrocyclone 20′. Path 38 includes in-line mixing apparatus 40. Also connected to path 38 is a second water miscible organic solvent source 24′, which in some embodiments is the same source as source 24. Thus, an additional amount of water miscible organic solvent 26, delivered from solvent source 24′, is added to the overflow in path 38, and the components are mixed with in-line mixing apparatus 40, resulting in precipitation of an additional amount of the salt present in the water, and the salt is separated from the mixture in hydrocyclone apparatus 20′. A concentrated salt slurry is separated from the mixture in hydrocyclone apparatus 20′ and is dispensed at exit point 32′ as an underflow, which is combined with the underflow from exit point 32 of hydrocyclone 20 and flows via pathway 36 to the system shown in FIG. 2A. Overflow from hydrocyclone 20′ proceeds via path 38′ to a third hydrocyclone 20″. Path 38′ includes in-line mixing apparatus 40′. Also connected to path 38′ is water miscible organic solvent source 24″, which in some embodiments is the same source as source 24 or source 24′. Thus, an additional amount of water miscible organic solvent 26, delivered from solvent source 24″, is added to the overflow in path 38′, and the components are mixed with in-line mixing apparatus 40′, resulting in precipitation of an additional amount of the salt present in the water, and the salt is separated from the mixture in hydrocyclone apparatus 20″. A concentrated salt slurry is separated from the mixture in hydrocyclone apparatus 20″ and is dispensed at exit point 32″ as an underflow, which is combined with the underflow from exit points 32 and 32′ of hydrocyclones 20 and 20′, respectively, and flows via pathway 36 to the system shown in FIG. 2A.

In this manner, an unlimited number of hydrocyclones 20n are arranged in series, wherein overflows from each of the 20n hydrocyclones proceed along each path 38n to the next hydrocyclone in the series, and in each of the paths 38n, water miscible organic solvent 26 from a source 24n delivers an aliquot of water miscible organic solvent 26 to the path 38n, resulting in precipitation of an additional amount of the salt present in the water. Mixing of the combined flows in each path 38n is accomplished by an in-line mixing apparatus 40n. Salt precipitated by the addition of water miscible organic solvent 26 from each source 24n is separated from the mixture in the corresponding hydrocyclone 20n apparatus. A concentrated salt slurry is dispensed at each exit point 32n as an underflow. The underflow from all exit points 32n of the hydrocyclones 20n is combined; the combined underflow proceeds via pathway 36 to the underflow separation system shown in FIG. 2A. The final separation from the last of the hydrocyclones 20n in the series results in the exiting of a solution of water and water miscible solvent via path 42. In some embodiments, the solution in path 42 is significantly free of salt. In other embodiments, the solution in path 42 is substantially free of salt.

Because the water miscible solvent does not form an azeotrope with water, the water miscible solvent is easily separated from the overflow exiting system 10 via path 42 by the use of conventional methods such as membrane separation or distillation.

In an embodiment including the use of conventional methods such as membrane separation, a certain amount of salt needs to be removed by the series of hydrocyclones so as to prevent fouling of the membranes. In other words, in such an embodiment, the goal is to achieve a salt concentration which would allow a membrane process to then become technically feasible. For a membrane process to become technically feasible, the osmostic pressure difference across the membrane, in one embodiment, may be less than 1,000 psi. The osmostic pressure difference across the membrane, P_{osmdiff} can be calculated as follows:

$${P}_{osmdiff} = [ ( \frac{{TDS}_{feed} + {TDS}_{Reject}}{2} ) - {TDS}_{Permeate} ] * 0.01 \frac{psi}{( mg / L )}$$

In certain embodiments, anywhere from 50% to 99.9% of the salt may have been precipitated out of the overflow water via the methods described herein.

The water miscible solvent is thus available for recycling and can be returned, for example, to a source 24n to be reused in system 10. In some embodiments, the overflow exiting system 10 via path 42 is sent to the system shown in FIG. 2A, or a separate but similar system to that shown in FIG. 2A.

It will be understood that the apparatus of the invention employs at least one hydrocyclone, and optionally employs more than one hydrocyclone such as two hydrocyclones, or the three or more hydrocyclones shown in FIG. 1, or 20n hydrocyclones. How many hydrocyclones are required to carry out effective separation will depend on many factors, including the specific water solution being addressed and the desired total percent separation of salt desired. In some embodiments, between 2 and 20 hydrocyclones are employed. The type of salt, the amount of salt, the presence of more than one species of salt, and the presence of additional dissolved materials within the water phase of the aqueous solution, for example are relevant considerations contributing to the optimized design of the system 10. Variations thereof will be easily envisioned by one of skill.

By employing system 10 and the described separation methodology, a significant amount of salt is separated from the starting solution of inorganic salt in water, when the final water-water miscible solvent mixture that leaves system 10 as overflow is compared to the original solution of inorganic salt in water. For example, in some embodiments, about 50% to 99.9% of the salt is separated from the starting solution of inorganic salt in water, wherein the inorganic salt is separated in the form of the salt slurry. In embodiments, substantially all the salt is separated from the starting solution of inorganic salt in water.

Both the overflow from the final hydrocyclone in the series of hydrocyclones 20n . . . and the combined underflows from each hydrocyclone 20n will contain the organic solvent. The underflows are the separated salt slurry from the aqueous mixture formed by adding the water-miscible solvent to the solution of the inorganic salt in water. The underflows are combined into a single stream that proceeds via path 36 to an underflow separation system. One embodiment of an underflow separation system is shown in FIG. 2A.

### Evaporation Apparatuses and Methods

Referring to FIG. 2A, a system 50 is shown that includes apparatus suitable for carrying out methods of various aspects of the invention. In the embodiment shown in FIG. 2A, system 50 enables the evaporation of the water miscible organic solvent 26 from the slurry, and further enables the optional separation of precipitated salt from the water, wherein one optional means for separating the precipitated salt from the water is shown in FIG. 2A. Underflow from path 36 of FIG. 1 is directed via path 52 of FIG. 2A to the top of evaporation vessel 54, via opening 56 of the enclosed top chamber 58 of vessel 54, aided by pump 60. Vessel 54 includes inlet 56 for the underflow, that is, the incoming salt slurry; top chamber 58; bottom chamber 62; outlet 64 for the concentrated salt slurry; optional jacketed area 66 with inlet 68 and outlet 70 for jacketed temperature control via addition of a heated fluid; and wetted wall separators 72 situated substantially vertically and disposed at least partially within top chamber 58 and bottom chamber 62.

Salt slurry, that is, the underflow 74 in path 36 from a separation system 10 such as that shown in FIG. 1 enters top chamber 58 by flowing along flow path 52 through inlet 56. When the level of underflow 74 in top chamber 58 reaches the level of the top openings 76 of the wetted wall separation tubes 72, it enters and flows down the hollow tubes 72, aided by gravity. As the liquid 74 proceeds down tubes 72, a lower pressure is applied at the top of the tubes 72 by applying a vacuum 78 along path 80 leading from the top chamber 58 of vessel 54. Optionally, instead of applying a vacuum, the lower pressure is applied in some embodiments by forcing an air flow from the bottom openings 82 of tubes 72, disposed within bottom chamber 62 of vessel 54, toward the top openings 76, such as by a blower (not shown). Application of lowered pressure aids in the evaporation of the water miscible solvent from the slurry, and the organic solvent is condensed and collected via path 80 and condensed via condenser 84, and the condensed water miscible solvent 26 is stored in storage tank 86. In some embodiments, this organic solvent is recycled back to the one or more sources such as sources 24n depicted in FIG. 1, for reuse in a subsequent separation.

Within the vessel 54, the tubes 72 have openings 76 that project into top chamber 58 and openings 82 that project into bottom chamber 62. Between top chamber 58 and bottom chamber 62 of vessel 54, an optional jacketed area 66 surrounds tubes 72; the optional jacketed area 66 has inlet 68 and outlet 70. In some embodiments, a heated fluid is pumped into inlet 68, for example, by a liquid pump or heated gas pump (not shown) and exits via outlet 70. As evaporation occurs within tubes 72, loss of heat of evaporation is mitigated by adding heat to the jacketed area 66.

In some embodiments, the wetted wall separation tubes achieve evaporation of the water-miscible solvent from the salt slurry while maintaining substantial separation of the precipitated salt, that is, preventing subsequent redissolution of the salt in the water as the water miscible solvent is evaporated. This is achieved by the helical threaded feature design of the tubes as well as the inner diameter thereof. In embodiments, the wetted wall separator tubes of the invention are characterized primarily by inner diameter defining the inner wall, and height of the tube in combination with the helical threaded feature defining at least a portion of the inner wall.

The rate of evaporation of the water miscible solvent from the salt slurry is determined by both the wetted wall separation tube itself and by additional factors. The tube properties affecting evaporation include the height of the tube, the helical threaded dimensions of the inner wall of the tubes and the portion of the inner wall having the helical threaded features thereon, and the heat transfer properties of the tube—that is, tube material properties, thickness of the tube, and presence of heat transfer features present on the outer surface of the tube. Additional factors include the heat of vaporization of the water miscible solvent, external temperature control, such as by a jacketed area 66 shown in FIG. 2A, and the amount of pressure differential within the hollow separator tube between the top and bottom of the tube length. The height of the tubes useful in the evaporation is not particularly limited, and will be selected based on the amount of water miscible solvent entrained in the slurry and the heat of evaporation of the water miscible solvent. In some embodiments, the height of the wetted wall separator tubes useful in conjunction with the separation of water miscible solvent from a slurry of sodium chloride in water, using ethylamine as the water miscible solvent, is about 50 cm to 5 meters, or about 100 cm to 3 meters. In embodiments, the portion of the total length of the tube that includes the helical threaded features present on the inner wall thereof is between about 50% and 100% of the total inner wall surface area, or about 90% to 99.9% of the total wall surface area, or about 95% to 99.5% of the total inner wall surface area.

Further detail regarding the inner and outer wall features of the wetted wall separation tubes are shown in FIG. 2B. FIG. 2B is a schematic representation of area 2B of FIG. 2A, wherein area 2B is a section of the length of the tube as indicated, further bisecting the tube in a plane extending lengthwise through the center thereof. The features of FIG. 2B are further defined by dimensions represented by lines a, b, and arrow lines 100, 102, 104, 112, 114, 116, 118, 124, 126, and 128. Arrows 100, 102, 104, 112, 114, 116, 118, 124, 126, and 128 of FIG. 2B are used where appropriate to describe the various features and dimensions of the indicated section 2B of wetted wall separation tubes 72 shown in FIG. 2A. It will be appreciated that the detailed schematic diagram of FIG. 2B is only one of many potential embodiments of the wetted wall separator tubes of the invention. Additional embodiments will be reached by optimization depending on the particular application to be addressed.

Referring to FIG. 2B, one embodiment of a wetted wall separation tube 72 section 2B is defined by effective outer diameter 100 and effective inner diameter 102 which together define the effective thickness 104 of tube section 2B. For purposes of separating an inorganic salt from water, the tube inner diameter 102 is between about 3 cm and 1.75 cm, or between about 2.5 cm and 1.9 cm. However, for other types of separations, the inner diameter 102 will be optimized to provide the required balance of flow differences between the solid phase and the liquid phase to maintain the solid within the helical grooves and allow the liquid to flow in substantially vertical fashion over the helix ribs when the selected slurry is added to the top opening 76 of wetted wall separation tubes 72. The inner diameter 102 of tube section 2B defines inner wall 106 of tube section 2B. Inner wall 106 includes a helical threaded section 108 defined by helix angle 110 which is defined in turn by lines a, b; helix pitch 112; helix rib height 114; helix base rib width 116, and helix top rib width 118. Helix “land” width is defined as the helix pitch 112 minus helix base rib width 116. Helical threaded section 108 of FIG. 2B is further defined for purposes of separating an inorganic salt from water as follows. In embodiments, the helix angle 110 is about 25° to 60° or about 30° to 50°, about 35° to 50°, or even about 38° to 48°. In embodiments, the helix pitch 112 is about 0.25 mm to 2 mm, or about 0.5 mm to 1.75 mm, or about 0.75 mm to 1.50 mm, or about 0.85 mm to 1.27 mm. In embodiments, the helix rib height 114 is about 25 μm to 2 mm, or about 100 μm to 1 mm, or about 200 μm to 500 μm. In some embodiments the helix rib height 114 is about 254 μm. In embodiments, the helix base rib width 116 is about 25 μm to 2 mm, or about 100 μm to 1 mm, or about 200 μm to 500 μm. In embodiments, the helix top rib width 118 is about 0 μm (defining a pointed tip with no “land”) to 2 mm. In some embodiments, helix rib top width 118 is the same or less than helix rib base width 116. In some embodiments, the helix rib profile is triangular or quadrilateral. The helix rib profile shape is triangular in embodiments where helix top rib width 118 is 0; a square or rectangular shape where helix top rib width 118 is the same as the helix base rib width 116; or a trapezoidal shape where helix rib top width 118 is greater than 0 but less than the helix rib base width 116. While helix rib shapes wherein helix rib top width 118 is greater than helix base rib width 116 are within the scope of the invention, in some embodiments, such features are difficult to impart to the interior of a tube such as tubes 72. Further, the helix rib top can be tilted with respect to the approximate plane of the surrounding wall; that is, angled with respect to the vertical plane. Providing a tilted helix rib top will, in some embodiments, increase or decrease the degree of turbulence generated in the flow of the liquid as it proceeds vertically within the tube.

Additionally, while the shape of the helix ribs are not particularly limited and irregular or rounded shapes for example are within the scope of the invention, in embodiments it is advantageous to provide a regular feature in order to maintain laminar flow within the helix land area. Further, in embodiments it is advantageous to provide an angular feature such as a trapezoidal or rectangular feature in order to incur some capillary pressure to maintain the laminar flow within the boundaries of the helix land area. However, it will be recognized by those of skill that machining techniques, such as those employed to machine a helical feature into the interior of a hollow metal tube, necessarily impart some degree of rounding to a feature where angles are intended. As such, in various embodiments the angularity of the features is subject to the method employed to form the helical threaded features that define the inner wall of 10 the wetted wall separation tubes of the invention.

Referring again to FIG. 2B, as noted above, the effective outer diameter 100 and effective inner diameter 102 together define the effective thickness 104 of tube section 2B. Effective thickness of the tube is, in various embodiments, about 0.1 mm to 10 mm, or about 0.25 mm to 3 mm, or 0.5 mm to 1 mm where the tube is fabricated from a metal, such as a stainless steel. However, the effective thickness of the tube is selected based on the material from which the tube is fabricated as well as heat transfer properties of the material and other features that will be described in more detail below, and also for convenience. It will be appreciated that an advantage of the wetted wall separator tubes of the invention is that the tubes do not include and are not contacted with moving machine parts, and are not subjected to harsh conditions or large amounts of abrasion, stress, or shear. Therefore, it is not necessary to provide very thick effective wall thickness of the tubes, nor is it necessary to fabricate the tubes from metal, in order to achieve the goal of evaporating the water miscible solvent from the slurry.

Referring again to FIG. 2B, the outer diameter 100 of tube section 2B defines outer wall 120 of tube section 2B. Outer wall 120 may include a series of fins 122 protruding from outer wall 120, wherein the fins are defined by fin thickness 124 and fin height 126. The fins are employed in embodiments for temperature control, for example by adding heat via the jacketed area 66 as shown in FIG. 2A, to increase the rate of heat transfer. In some embodiments (not shown), there is land between the fins; in other embodiments the fins do not have land area between them. The purpose of the fins inside the pipe is to break up the liquid flow into smaller streams and create turbulence, which increases the contact surface area between the gas and liquid phases. The purpose of the corrugated fins outside the tube is to increase the surface area between the fluid outside the tubes and the liquid flowing down inside the tubes, so we can heat/cool the liquid effectively.

The shape of the fins are not particularly limited and in various embodiments rounded, angular, rectilinear or irregularly shaped fins are useful. The dimensions of the fins are not particularly limited and are determined by employing conventional heat transfer calculations optimized for the targeted evaporation process. In some embodiments, the fins have fin thickness, or width, 124 of about 0.1 mm to 10 mm, or about 0.5 mm to 5 mm, or about 0.75 mm to 2 mm. In some embodiments, the fins have fin height 126 roughly the same as the fin thickness. The dimension of the fins is incorporated into the total width 128 of the tubes. In some embodiments, instead of fins encircling the tubes, discrete projections protrude from the outer walls in selected locations. In some embodiments, the fins or projections are present over a portion of the outer wall wetted wall separator tubes; in other embodiments the fins or projections are present over the entirety thereof. However, the presence of any fins or projections is optional and in some embodiments fins or projections are unnecessary to achieve effective evaporation of the water miscible solvent.

An additional optional feature of the wetted wall separator tubes of the invention includes an entry section proximal to the top openings of the tubes that facilitates and establishes a suitable flow of the slurry entering the tube. The entry section includes the top opening and a first portion of the inner wall of the tube. A suitable flow is created when slurry enters the tube in a volume and flow pattern enter the helical threaded portion of the tube in a manner wherein the solids tend to enter the helical threaded area beneath the entry section and flow in laminar fashion within the land area between the helix ribs, and the bulk of the liquid phase tends to flow substantially vertically within the tube, further wherein the vertical flow is turbulent by virtue of passing over the helix rib features. The design of the entry section will vary depending on the nature of the slurry as well as the design of the helical thread situated further along the tube as the slurry proceeds vertically. For separation of a slurry of sodium chloride, we have found that the entry section optionally includes weirs proximal to the top opening, and a smooth inner wall extending from the top opening to the onset of the helical threaded portion of the tube. The weirs are designed to provide a substantially laminar flow of slurry at a suitable volume for flowing across and into the helical threaded area of the inner wall of the tube. In some embodiments, the weirs are rounded features, such as o-ring shaped features, placed proximal to and above the top opening, that facilitate slurry flow into the tube such that the flow proceeds in contact with the inner wall thereof. In other embodiments, the weirs are a series of walls, slotted features, or perforated openings disposed above and extended across the top opening, and shaped to provide flow of the slurry into the tube such that the flow proceeds in contact with the inner wall thereof. In some such embodiments, the weirs also regulate the rate of flow into the tube. The weirs are formed from the same or a different material or blend of materials than the tube itself, without limitation and for ease of manufacture, provision of a selected surface energy, or both.

In embodiments, the weirs are followed, in a portion of the tube proximal to and below the top opening, by a smooth inner wall section. The smooth inner wall section is characterized by a lack of a helical threaded feature or any other feature that causes disruption of the slurry in establishing a laminar downward flow within the tube. In embodiments, the smooth inner wall section extends vertically from the top opening of the tube to about 0.5 mm to 10 mm from the top opening of the tube, or about 1 mm to 5 mm from the top opening of the tube. Proximal to the smooth inner wall section in the vertical downward direction, the helical threaded portion of the inner wall begins. In some embodiments the smooth inner wall section has a substantially cylindrical shape; in other embodiments it has a frustoconical shape; that is, the smooth inner wall of the tube is frustoconical leading to the helical threaded inner wall portion. The frustoconical shape is not necessarily mirrored on the outer wall of the tube, though in embodiments it is. In general, where the smooth inner wall section has a frustoconical shape, the conical angle is about 1° to 10° from the vertical.

It will be understood that the fins on the outer wall of the wetted wall separator tubes, as shown in FIG. 2B, weirs, and a smooth inner wall section are optional features, and that the only feature necessary to the wetted wall separator tubes of the invention are the basic hollow cylinder or frustoconical shape having an inner wall and an outer wall wherein a helical threaded feature defines at least a portion of the inner wall. In embodiments, the helical threaded feature extends over a significant portion of the inner wall, and in other embodiments the helical threaded feature extends over substantially the entirety of the inner wall. In still other embodiments, the helical threaded feature extends over substantially the entirety of the inner wall except for the smooth inner wall portion of the tube as described above.

In the evaporation systems of the invention, such as the system 50 shown in FIG. 2A, there is at least one wetted wall separation tube 72. The number of tubes employed, in an array of tubes contained within an evaporation apparatus, is not limited and is dictated by the rate of delivery of slurry into the apparatus. In some embodiments, an evaporation apparatus of the invention includes between 2 and 2000 wetted wall separation tubes, disposed substantially vertically and parallel to each other and having the top openings 76 substantially in the same plane. In some embodiments where two or more tubes are present in an evaporation apparatus, the tubes are placed far enough apart from one another to provide for efficient heat transfer with the surrounding environment; where a jacketed area surrounds the tubes this spacing must account for efficient flow of the heat transfer fluid around and between the tubes. It will be appreciated that the number of tubes present in a particular evaporation apparatus of the invention will be adjusted based on the selected flow rate of slurry delivered by the precipitation apparatus such as the apparatus of FIG. 1. In some embodiments, more than one evaporation apparatus 54 is connected to path 52, or chamber 58 is split into two or more chambers, in order to address total flow of slurry from flow path 52 into the tubes 72. Such compartmentalized control is useful because tubes 72 have a range of flow operability, that is, a minimum and a maximum flow capacity wherein turbulent wetted wall flow is achieved. Higher flow rates from flow path 52 require the use of more tubes, once the maximum flow capacity of one tube or one group of tubes is reached.

The wetted wall separation tubes of the invention are not particularly limited as to the materials used to form them. Layered or laminated materials, blends of materials, and the like are useful in various embodiments to form the wetted wall separation tubes of the invention. Materials that form the inner wall and thus the helical threaded features are selected for machining or molding capability, imperviousness to the materials to be contacted with the inner wall, durability to abrasion from the particulates in the slurries contacted with the inner wall, heat transfer properties, and surface energy of the material selected relative to the surface tension of the slurry to be contacted with the inner wall. In various embodiments, the wetted wall separator tubes of the invention are formed from metal, thermoplastic, thermoset, ceramic or glass materials as determined by the particular use and temperatures encountered. Metal materials that are useful are not particularly limited but include, in embodiments, single metals such as aluminum or titanium, alloys such as stainless steel or chrome, multilayered metal composites, and the like. It is important to select a metal for the inner wall of the tubes that is impervious to water, salt water, or the selected water miscible solvent. In some embodiments, metals have the additional advantage of providing excellent heat transfer, and so are the material of choice. In some embodiments, stainless steel is a suitable material for use in conjunction with the separation of sodium chloride from water. In some embodiments, it is advantageous to employ thermoplastic materials as part of, or as the entire composition of the tubes due to ease of machining or to minimize cost, or both. Further, in embodiments thermoplastics may be molded around a helically-shaped template and the helical threaded features imparted to the molded tubes are, in some embodiments, more defect-free than their metal counterparts. However, a thermoplastic selected to compose the inner wall of the tube must be substantially impervious to any effects of swelling or dissolution by water, salt water, or the selected water miscible solvent and substantially durable to the abrasion provided by movement of slurry particles within the tubes. Examples of suitable thermoplastics for some applications include polyimides, polyesters, polycarbonate, polyurethanes, polyvinylchloride, fluoropolymers, chlorofluoropolymers, polymethylmethacrylate, polyolefins, copolymers or blends thereof, and the like. The thermoplastics further include, in some embodiments, fillers or other additives that modify the material properties in a way that is advantageous to the overall properties of the tube, such as by increasing abrasion resistance, increasing heat resistance, raising the modulus, or the like. Thermosets are typically crosslinked thermoplastics wherein the crosslinking provides additional dimensional stability during e.g. temperature changes or any tendency of the polymer to dissolve or degrade in the presence of water, salt water, or the selected water miscible solvent. Radiation crosslinked polyolefins, for example, are suitable for some applications to form the inner wall or the entirety of a wetted wall separation tube of the invention. Ceramic or glass materials are also useful materials from which to form the wetted wall separation tubes of the invention and are easily machined to high precision in some embodiments.

The wetted wall separation tubes are particularly well suited for providing a means for evaporating the water miscible organic solvent from the salt slurry formed using the methods of the invention. It is an advantage of the wetted wall separation tubes that no moving parts reside within the tubes; and that the tubes are of simple design; and that the tubes contain no features that tend to collect and/or aggregate the slurry particles. The evaporation of the water miscible solvent is highly efficient using the wetted wall separation tubes of the invention, and the solid slurries particles are able to proceed in unfettered fashion downward through the tube. The wetted wall separation tubes provide a high surface area between the liquid and gas phases, allowing substantially all of the water miscible solvent to be recovered by evaporation and resulting in an overall efficient and rapid evaporation process. Because the salt crystals formed during the fractional addition of the water miscible solvent are small, they can be carried down the tubes along with some amount of liquid, in some embodiments in a substantially laminar flow that follows the helical threaded pathway.

Referring once again to FIG. 2A, after evaporation from the wetted wall separation tubes 72, a concentrated salt slurry 150 exits tubes 72 at bottom openings 82 thereof. The precipitated salt and water, now substantially free of water miscible solvent, flow into bottom chamber 62 and exit outlet 64 as a concentrated salt slurry. In some embodiments, the salt crystals have been subjected to substantially laminar flow and do not tend to redissolve in the water as the water miscible solvent is removed from the turbulent flow. Thus, the crystals are easily isolated from the concentrated salt slurry exiting tubes 72 at bottom openings 82. The concentrated salt slurry is deposited into a collection apparatus 152. Collection apparatus 152 as shown is the same or similar to cylinder formers developed for papermaking applications, as will be appreciated by those of skill Cylinder former 152 includes a horizontally situated cylinder 154 with a wire, fabric, or plastic cloth or scrim surface that rotates in a vat 156 containing the concentrated salt slurry 150 delivered from exit outlet 64. Water associated with the slurry 150 is drained through the cylinder 154 and a layer of precipitated salt is deposited on the wire or cloth, and exits collection apparatus 152 via pathway 158. The drainage rate, in some designs, is determined by the slurry concentration and treated water level inside the cylinder such that a pressure differential is formed. As the cylinder 154 turns and water is drained from the slurry, the precipitate layer that is deposited on the cylinder is peeled or scraped off of the wire or cloth, such as with a scraper blade 160 or some other apparatus, and continuously transferred, such as via a belt 162 or other apparatus, to receptacle 164. In some embodiments, during transport of the deposited layer of salt 166 to the receptacle 164, the salt is dried, such as by applying a hot air knife (not shown) across the belt 162 or by heating belt 162 directly, or by some other conventional means of drying salt crystals.

In some embodiments, water exiting collection apparatus 152 via pathway 158 is sent to a subsequent treatment apparatus, such as ultrafiltration or nanofiltration, in order to remove the remaining salt or another impurity.

The following Examples further exemplify and demonstrate the principles of the various aspects of the present invention described above.

### EXAMPLES

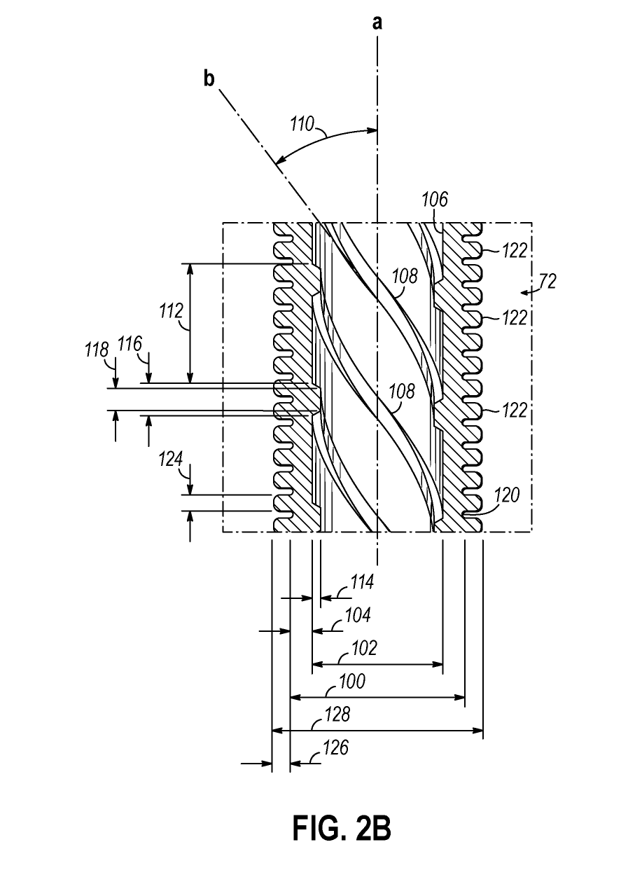

An experimental evaporation setup 168 was built as shown in FIG. 3. Referring to FIG. 3, a 900 mm length of corrugated PVC pipe 170 having an outer diameter of 32 mm and nominal inner diameter of 25.4 mm (CORRFOAM®, obtained from ILPEA Industries of Cleveland, Ohio) was mounted vertically and attached to a trough 172 and collection tank 174. A feed tank 176 containing a solution 178 of 300-500 ppm ammonia in water was attached to a liquid pump 180 and tubing 182 was used to connect the feed tank 176 and liquid pump 180 to the chamber 172. Chamber 172 was further attached to vacuum pump 184. The pipe 170 was perforated 186 near the bottom but above collection tank 174 and a valve 188 attached to the perforation as a means to control the amount of air to be pulled upwards through the tube 170 by vacuum pump 184. Corrugated PVC pipe 170 had base inner diameter of 27.94 mm, corrugation rib height of 4.32 mm, corrugation rib width, at rib top, of 1.91 mm, and corrugation rib pitch of 3.68 mm.

The ammonia solution 178 was drawn from the feed tank 176 by liquid pump 180 and dispensed into chamber 172 at a series of selected rates ranging from 20 mL/min to 280 mL/min, and the solution was allowed to flow into and downward within pipe 172 and into collection tank 174. The amount of air allowed into the pipe 170 during the liquid flow was about 1-2 mL/min, such that by turning on the vacuum pump 184 a vacuum level of about 300 mm Hg was maintained in the pipe 170 at steady-state operation. The temperature of the environment surrounding the setup was 25° C.

Ammonia analyzers (AAM631 Aztec 600 ISE, available from ABB Inc. of Warminster, Pa.) were used to measure the concentration of ammonia in the water. One analyzer was used to measure the ammonia level in the trough 172, and a second analyzer was used to measure ammonia in the collection tank 174.

The inlet and outlet ammonia concentrations, together with pH and temperature measurements allowed the determination of the loss of ammonia from the water during the test. The results are shown in Table 1. The data in Table 1 was used to determine the liquid-phase mass transfer coefficient, and the dimensionless mass transfer number was plotted versus the Reynolds Number, wherein the Reynolds Number is calculated according to the equation:

Re=4Q/υW

where Q is the liquid flow rate, υ is the kinematic viscosity, and W is the pipe perimeter.

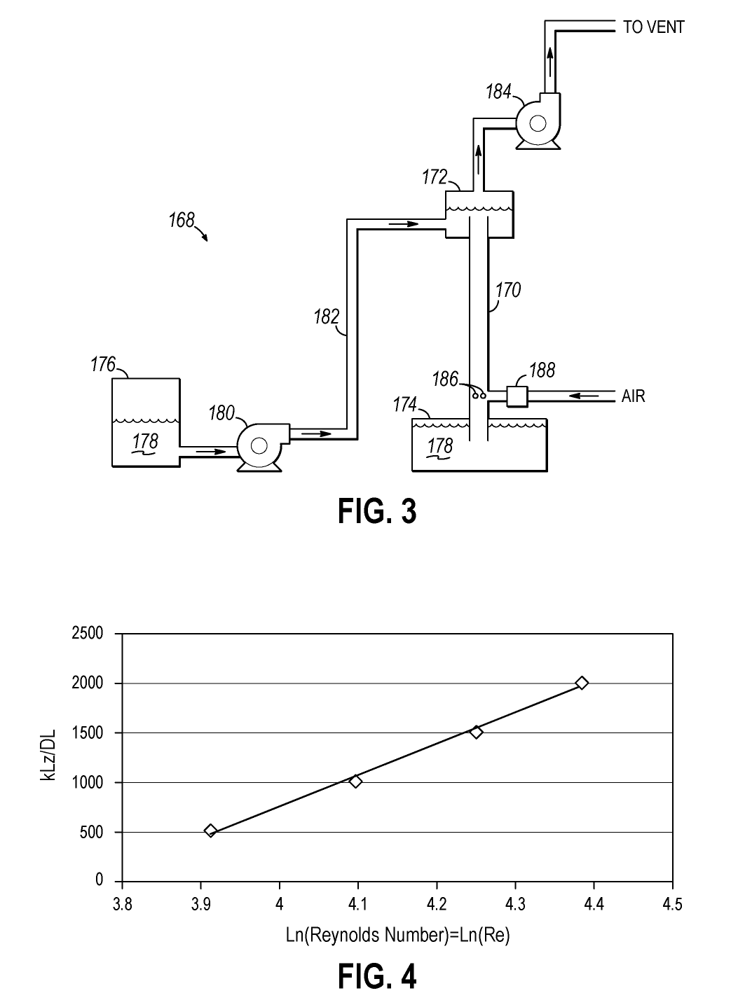

The experiment was repeated with a PVC pipe (also obtained from ILPEA Industries of Cleveland, Ohio) without interior corrugation—that is, having a substantially smooth inner wall—and the measurements were used to determine the liquid-phase mass transfer coefficient, and the dimensionless mass transfer number was plotted versus the Reynolds Number. Mass transfer number as a function of the Reynolds Number for the control experiment is shown in FIG. 4, where mass transfer number is

kLz/DL

where kL is the mass transfer coefficient, z is the height of the PVC pipe, and DL is diffusivity of ammonia in water.

TABLE 1
Ammonia measured in the influent and effluent water for corrugated
and plain PVC pipe.

| Influent Water | | | | | | |
|---|---|---|---|---|---|---|
| (100 mL/min) | | | | | | |
| | Tem- | | Effluent Water | | | |
| | pera- | | | Tempera- | | |
| | ture | NH3—N | | ture | NH3—N | % NH3—N |
| pH | (° C.) | (mg/L) | pH | (° C.) | (mg/L) | Removal |

Corrugated Tube

| | | | | | | |
|---|---|---|---|---|---|---|
| 8.0 | 22 | 28.8 | 8.0 | 16 | 18.2 | 37 |
| 8.6 | 21 | 26.6 | 8.1 | 17 | 15.8 | 41 |
| 9.3 | 23 | 26.2 | 8.6 | 18 | 5.3 | 80 |
| 9.7 | 21 | 30.0 | 9.1 | 16 | 2.1 | 93 |
| 10.8 | 22 | 25.5 | 10.1 | 17 | 0.6 | 98 |

Plain Tube

| | | | | | | |
|---|---|---|---|---|---|---|
| 8.0 | 22 | 32.0 | 8.0 | 22 | 31.4 | 1.9 |
| 8.6 | 21 | 28.9 | 8.1 | 21 | 27.3 | 5.5 |
| 9.3 | 23 | 26.2 | 8.6 | 19 | 25.6 | 2.3 |
| 9.7 | 21 | 32.1 | 9.1 | 22 | 31.0 | 3.4 |
| 10.8 | 22 | 23.8 | 10.1 | 20 | 22.9 | 3.8 |

Data for the corrugated pipe gave mass transfer coefficient (kL) values which were 10-20 times higher than the values obtained for the smooth pipe. This showed that using a corrugated pipe produced significant turbulence in the liquid film, which enhanced the rate of mass transfer of the ammonia from the water into the gas phase.

While the present invention has been disclosed by reference to the details of preferred embodiments of the invention, it is to be understood that the disclosure is intended as an illustrative rather than in a limiting sense, as it is contemplated that modifications will readily occur to those skilled in the art, within the spirit of the invention and the scope of the amended claims.

We claim:

1. A system for separating a solvent from an aqueous mixture, the system comprising:
(a) a separator including:
i. a housing having at least one wall defining an interior space, an open top end, and an open bottom end, wherein the at least one wall has an inner surface and an outer surface; and
ii. a contour disposed on, or in, or defined by, at least a portion of the inner surface of the at least one wall;
(b) wherein a flow path for an aqueous mixture is provided by at least a portion of the contour and the inner surface of the at least one wall.

2. The system of claim 1, wherein the aqueous mixture includes water and a solvent.

3. The system of claim 1, wherein the aqueous mixture includes, water, a solvent, and precipitated salt.

4. The system of claim 1, wherein the contour is continuous from substantially the open top end of the separator to the open bottom end of the separator.

5. The system of claim 4, wherein the contour is substantially of a single cross-sectional dimension along the length of the contour.

6. The system of claim 4, wherein a cross-sectional shape of the contour is substantially the same along the length of the contour.

7. The system of claim 1, further comprising a vacuum source operatively coupled to the open top end of the separator.

8. The system of claim 1, further comprising a gas source operatively coupled to the open bottom end of the separator.

9. The system of claim 1, wherein the at least one wall forms a cylindrical tube structure.

10. The system of claim 9, wherein the open top end and the open bottom end define the tube length, wherein the tube length is about 50 cm to 5 meters.

11. The system of claim 9, wherein the contour is a helical threaded feature.

12. The system of claim 11, wherein the helical threaded feature is disposed on about 50% to 100% of the inner wall surface area.

13. The system of claim 1, wherein the at least one wall defines an inner diameter of about 3 cm to 1.75 cm.

14. The system of claim 11, wherein the helical threaded feature comprises a helix angle of about 25° to 60°.

15. The system of claim 11, wherein the helical threaded feature comprises a rib area and a land area defining a pitch, wherein the pitch is about 0.25 mm to 2 mm.

16. The system of claim 11, wherein the helical threaded feature comprises a rib area and a land area, wherein the rib area has a profile that is substantially triangular or quadrilateral.

17. The system of claim 16, wherein the rib area defines a helix rib base width, wherein the helix rib base width is about 25 μm to 2 mm.

18. The system of claim 16, wherein the rib area is quadrilateral and defines a helix rib top width, wherein the helix rib top width is about 25 μm to 2 mm.

19. The system of claim 1, further comprising a second wall having an inner surface and an outer surface, wherein the second wall is positioned such that the inner surface of the second wall faces the outer surface of the at least one wall, and wherein an interior space is defined between the second wall and the at least one wall.

20. The system of claim 19, wherein the at least one wall and the second wall together define a two-wall thickness, and wherein the two-wall thickness is about 0.1 mm to 10 mm.

21. The system of claim 19, wherein the second wall comprises one or more fins extending away from the outer surface of the second wall.

22. The system of claim 1, wherein the separator further comprises an entry section proximal to the open top end, the entry section comprising a smooth inner wall section.

23. The system of claim 22, wherein the entry section is frustoconical, wherein the conical angle is about 1° to 10° from the vertical.

24. The system of claim 1, wherein the separator comprises one or more wires extending across the open top end.

25. The system of claim 1, wherein the separator is a wetted wall separator tube comprising a hollow cylindrical pipe having a top opening, a bottom opening, an inner wall, and an outer wall, and comprising a helical threaded feature disposed on at least a portion of the inner wall.

26. An evaporator apparatus comprising one or more wetted wall separator tubes of claim 25.

27. The evaporator apparatus of claim 26, further comprising a jacketed area equipped to accept and circulate a heated fluid, wherein the jacketed area surrounds a portion of the wetted wall separator tubes.

28. The evaporator apparatus of claim 26, wherein a vacuum source is in disposed in fluid communication with the top opening of the one or more wetted wall separation tubes.

29. The evaporator apparatus of claim 26, wherein a source of gas pressure is disposed in fluid communication with the bottom opening of the one or more wetted wall separation tubes.

30. The evaporator apparatus of claim 26, wherein the apparatus comprises between 2 and 2000 wetted wall separation tubes, wherein the tubes are arranged substantially vertically and wherein the top openings thereof are arranged in substantially planar fashion.

31. The evaporator apparatus of claim 26, further comprising a collection apparatus attached to the evaporator apparatus and situated to collect precipitated solids exiting the bottom opening of the one or more wetted wall separation tubes.

32. The evaporator apparatus of claim 26, further comprising a condenser apparatus attached to the evaporator apparatus and situated to condense a water miscible solvent exiting the top opening of the one or more wetted wall separation tubes.

33. A wetted wall separator tube comprising a hollow cylindrical pipe having a top opening, a bottom opening, an inner wall, and an outer wall, and comprising a helical threaded feature disposed on at least a portion of the inner wall.
